(19) United States
(12) Patent Application Publication
(10) Pub. No.: US 2026/0369208 A1
(43) Pub. Date: Nov. 19, 2026

(54) BOUNCING-CONTROLLED COMMON VOLTAGE BUFFER AND SOURCE DRIVER THEREOF

(71) Applicant: Samsung Electronics Co., Ltd., Suwon-si (KR)

(72) Inventors: Yu An LIN, Zhubei City (TW); Zhen Guo DING, Zhubei City (TW); Yu Chieh HUANG, Zhubei City (TW); Jia Wei CHEN, Zhubei City (TW)

(73) Assignee: Samsung Electronics Co., Ltd., Suwon-si (KR)

(21) Appl. No.: 19/434,317

(22) Filed: Dec. 29, 2025

(30) Foreign Application Priority Data
May 16, 2025 (TW) 114118358

(51) Int. Cl. G09G 3/20

(52) U.S. Cl. CPC G09G 3/2092; G09G 2310/0289; G09G 2310/0291

(57) ABSTRACT

Example embodiments are directed to a bouncing-controlled common voltage buffer and a source driver thereof. The common voltage buffer includes a P-type output transistor, an N-type output transistor, an output control circuit, and a bouncing-controlled circuit. The P-type output transistor is coupled between a system high voltage and a system middle voltage and receives a pull-up control signal. The N-type output transistor is coupled between the system middle voltage and a system low voltage, and receives a pull-down control signal. The output control circuit provides the pull-up control signal and the pull-down control signal. The bouncing-controlled circuit receives a comparison voltage and the system middle voltage, and turns on the P-type output transistor or the N-type output transistor through the pull-up control signal or the pull-down control signal when the system middle voltage exceeds a voltage range.

### CROSS-REFERENCE TO RELATED APPLICATION

This U.S. non-provisional application claims priority under 35 U.S.C. § 119 to Taiwanese Patent Application Nos. 114118358, filed on May 16, 2025, in the Taiwan Intellectual Property Office, the disclosure of which is incorporated by reference herein in its entirety.

### BACKGROUND

Example embodiments relate to a bouncing-controlled common voltage buffer and a source driver thereof.

With increase in demand for high-energy efficiency, it is beneficial to reduce coordinated direct current (DC) power and alternating current (AC) power in organic light-emitting diode (OLED) and liquid-crystal display (LCD) systems. In source driver integrated circuits (SDICs), in order to limit DC power, the operating voltage of elements within the source driver IC reduced to approximately half of the system high voltage (also referred to as VDD2M). To lower the cost for display system, the operating voltage of elements is generated by one of the common voltage (VCOM) buffers in the SDICs, rather than being supplied by the power management integrated circuit (PMIC).

Class AB push-pull amplifiers are preferred as common voltage buffers due to their relatively higher output charging and discharging capabilities. Conventional class AB push-pull amplifiers are current-biased from VDD2M based current generators in SDICs and may have a limited dynamic range. During power-up, when VDD2M is relatively closer to the system low voltage, operation of the common voltage buffer may be limited. It may be challenging to perform start-up using common voltage buffers with half-system high voltage mode. Furthermore, overshoot/undershoot problems may be observed in class AB push-pull amplifiers during load transients, line transients, and power/ground bouncing, resulting in increased AC power consumption.

### SUMMARY

Example embodiments provide a bouncing-controlled common voltage buffer and a source driver thereof for booting in ultra-low power display systems. In addition, example embodiments may reduce DC/AC power consumption while maintaining quiescent current (IQ) requirements and circuit area occupied.

A bouncing-controlled common voltage buffer of the present disclosure includes a P-type output transistor, an N-type output transistor, an output control circuit and a bouncing—controlled circuit. The P-type output transistor has a first terminal receiving a system high voltage, a control terminal receiving a pull-up control signal, and a second terminal outputting a system middle voltage. The N-type output transistor has a first terminal coupled to the second terminal of the P-type output transistor, a control terminal receiving a pull-down control signal, and a second terminal receiving a system low voltage. The output control circuit receives a comparison voltage, the system middle voltage, and multiple biases to provide the pull-up control signal and the pull-down control signal. The bouncing-controlled circuit receives the comparison voltage and the system middle voltage, and is coupled to the pull-up control signal and the pull-down control signal, and configured to compare the comparison voltage with the system middle voltage. When a voltage level of the system middle voltage exceeds a voltage range based on the voltage level of the comparison voltage, the bouncing-controlled circuit turns on one of the P-type output transistor and the N-type output transistor through the pull-up control signal or the pull-down control signal.

The source driver of the present disclosure includes the bouncing-controlled common voltage buffer as described above, a full range bias circuit, a half range bias circuit, a level shifter, multiple gamma amplifiers, a digital-to-analog converter, and a source amplifier. The full range bias circuit provides a positive global bias and a negative global bias. The half range bias circuit is coupled to the full range bias circuit and the bouncing-controlled common voltage buffer to provide the bias, a first operation bias, and a second operation bias based on the positive global bias, the negative global bias, and the system middle voltage. The level shifter is coupled to the half range bias circuit and the bouncing-controlled common voltage buffer, and receives display data to perform operations based on the first operation bias, the second operation bias, and the system middle voltage, and provides shift display data. The multiple gamma amplifiers are coupled to the half range bias circuit and the bouncing-controlled common voltage buffer, and receive comparison voltages separately, wherein the gamma amplifiers perform operations based on the first operation bias, the second operation bias, and the system middle voltage, and provide gamma voltages separately. The digital-to-analog converter is coupled to the level shifter and the gamma amplifiers to provide output gamma voltages based on the shift display data and the gamma voltages provided by the gamma amplifiers. The source amplifier is coupled to the digital-to-analog converter, the half range bias circuit, and the bouncing-controlled common voltage buffer to perform operations based on the first operation bias, the second operation bias, and the system middle voltage, and provides source voltage based on the output gamma voltage.

According to some example embodiments, a method of operating a bouncing-controlled common voltage buffer includes receiving a system high voltage through a first terminal of a P-type output transistor of the bouncing-controlled common voltage buffer, a pull-up control signal through a control terminal of the P-type output transistor, and outputting a system middle voltage through a second terminal of the P-type output transistor; receiving a pull-down control signal through a control terminal of an N-type output transistor, the N-type output transistor having a first terminal coupled to the second terminal of the P-type output transistor and receiving a system low voltage through a second terminal of the N-type output transistor; receiving a comparison voltage, the system middle voltage, and a plurality of biases through an output control circuit, and outputting the pull-up control signal and the pull-down control signal using the output control circuit; receiving the comparison voltage and the system middle voltage using a bouncing-controlled circuit, the bouncing-controlled circuit being coupled to the pull-up control signal and the pull-down control signal; comparing the comparison voltage with the system middle voltage using the bouncing-controlled circuit; and in response to a voltage level of the system middle voltage exceeding a voltage range based on a voltage level of the comparison voltage, turning on one of the P-type output transistor and the N-type output transistor through the pull-up control signal or the pull-down control signal.

According to some example embodiments, the method of operating the bouncing-controlled common voltage buffer further includes receiving the comparison voltage through a control terminal of a first N-type transistor of the bouncing-controlled common voltage buffer, and receiving the system middle voltage through a second terminal of the first N-type transistor, wherein the first N-type transistor includes a first terminal coupled to the pull-up control signal; and receiving the system middle voltage through a first terminal of a first P-type transistor of the bouncing-controlled common voltage buffer, and receiving the comparison voltage through a control terminal of the bouncing-controlled common voltage buffer, wherein a second terminal of the bouncing-controlled common voltage buffer is coupled to the pull-down control signal. According to some example embodiments, the voltage range is determined by the comparison voltage, a first transistor threshold for turning on the first P-type transistor, and a second transistor threshold for turning on the first N-type transistor. According to some example embodiments, a high voltage threshold of the voltage range is the comparison voltage plus the first transistor threshold, and a low voltage threshold of the voltage range is the comparison voltage minus the second transistor threshold.

Based on the above, when the voltage level of the system middle voltage exceeds the voltage range of the voltage level based on the comparison voltage, the bouncing-controlled common voltage buffer and the source driver thereof, according to some example embodiments, turn on one of the P-type output transistor and N-type output transistor through the pull-up control signal or the pull-down control signal, so that the system middle voltage is maintained within the voltage range. In this way, booting operation is performed in ultra-low power consumption display systems, and DC/AC power consumption is reduced.

To make understand the above features and advantages of the example embodiments, embodiments are described below in conjunction with the attached drawings.

### BRIEF DESCRIPTION OF THE DRAWINGS

FIG. 1 is a circuit diagram of a bouncing-controlled common voltage buffer according to some example embodiments.

FIG. 2 is a system diagram of a source driver according to some example embodiments.

FIG. 3 is a circuit diagram of a half range bias circuit according to some example embodiments.

FIG. 4 illustrates a boot simulation waveform diagram of common voltage buffers with and without bouncing-controlled circuits.

FIG. 5 illustrates a load transient simulation waveform diagram of common voltage buffers with and without bouncing-controlled circuits.

FIG. 6 illustrates an operation diagram of a common voltage buffer without a bouncing-controlled circuit when the system middle voltage is higher than the maximum value.

FIG. 7 illustrates an operation diagram of a common voltage buffer without a bouncing-controlled circuit when the system middle voltage is lower than the minimum value.

FIG. 8 illustrates an operation diagram of a common voltage buffer with a bouncing-controlled circuit when the system middle voltage is higher than the high voltage threshold of the voltage range.

FIG. 9 illustrates an operation diagram of a common voltage buffer with a bouncing-controlled circuit when the system middle voltage is lower than the low voltage threshold of the voltage range.

FIG. 10 illustrates an operation diagram of a common voltage buffer with a bouncing-controlled circuit when the system middle voltage is within the voltage range.

FIG. 11 illustrates a circuit diagram of a half range bias circuit for simulation environment settings to perform DC stable operating point check on a common voltage buffer.

FIG. 12 illustrates a simulation waveform diagram of a common voltage buffer without a bouncing-controlled circuit performing DC stable operating point check.

FIG. 13 illustrates a simulation waveform diagram of a common voltage buffer with a bouncing-controlled circuit performing DC stable operating point check.

### DESCRIPTION OF THE EMBODIMENTS

Unless otherwise defined, all terms (including technical and scientific terminology) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure and will not be interpreted in an idealized or overly formal sense unless expressly so defined herein.

It should be understood that although the terms “first”, “second”, “third”, etc. may be used herein to describe various elements, parts, areas, layers and/or portions, these elements, parts, areas, layers and/or portions should not be limited by these terms. These terms are only used to distinguish one element, part, area, layer or portion from another element, part, area, layer or portion. Thus, a “first element”, “part”, “area”, “layer” or “portion” discussed below could be termed a second element, part, area, layer or portion without departing from the teachings herein.

The terminology used herein is for the purpose of describing particular embodiments only and is not intended to be limiting. As used herein, unless context clearly indicates otherwise, the singular forms “a”, “an” and “the” are intended to include the plural forms, including “at least one”. “Or” means “and/or”. As used herein, the term “and/or” includes any and all combinations of one or more of the associated listed items. It should also be understood that when used in this specification, the terms “comprises” and/or “comprising” specify the presence of stated features, areas, integers, steps, operations, elements, and/or components, but do not preclude the presence or addition of one or more other features, areas, integers, steps, operations, elements, components, and/or combinations thereof.

Example embodiments provide a bouncing-controlled common voltage buffer that implements a startup operation that occupies relatively smaller area and a source driver using the bouncing-controlled common voltage buffer. Furthermore, the provided architecture further reduces AC power consumption while maintaining quiescent current (IQ) within the occupied area. In other words, the common voltage buffer/source driver according to some example embodiments has a relatively smaller area and lower DC/AC power consumption.

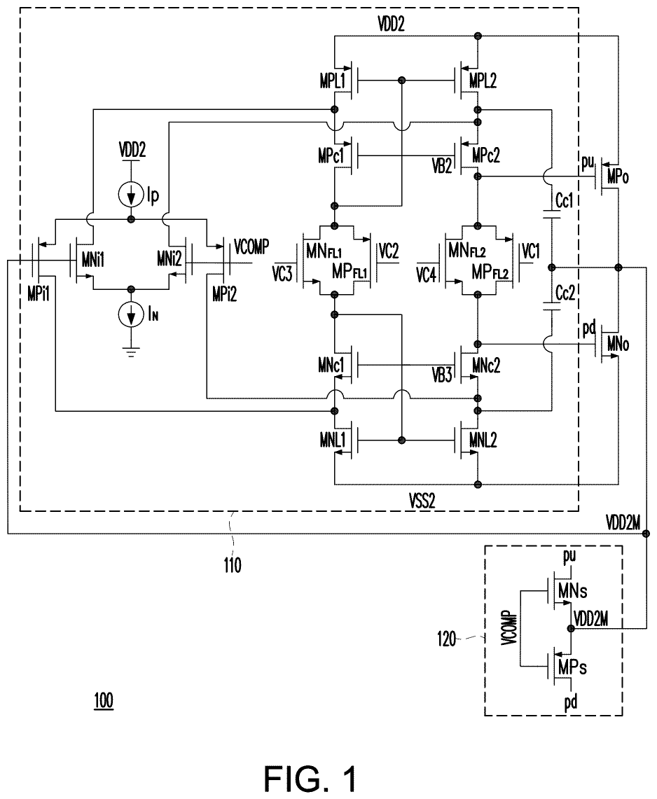

FIG. 1 is a circuit diagram of a bouncing-controlled common voltage buffer according to some example embodiments. Referring to FIG. 1, the bouncing-controlled common voltage buffer 100 (or simply, common voltage buffer 100) includes a P-type output transistor MP_{O}, an N-type output transistor MN_{O}, an output control circuit 110, and a bouncing-controlled circuit 120. The P-type output transistor MP_{O} has a first terminal receiving a system high voltage VDD2, a control terminal receiving a pull-up control signal pu, and a second terminal outputting the system middle voltage VDD2M. The N-type output transistor MN_{O} has a first terminal coupled to the second terminal of the P-type output transistor MP_{O}, a control terminal receiving the pull-down control signal pd, and a second terminal receiving the system low voltage VSS2.

The output control circuit 110 receives a comparison voltage VCOMP, a system middle voltage VDD2M, and multiple biases (such as biases VB2, VB3, VC1-VC4) to provide a pull-up control signal pu and a pull-down control signal pd, wherein the comparison voltage VCOMP and system middle voltage VDD2M determine the rising and falling of the pull-up control signal pu and pull-down control signal pd, and biases VB2, VB3, VC1 to VC4 determine the rising and falling speeds or rates of the pull-up control signal pu and pull-down control signal pd. The bouncing-controlled circuit 120 receives the comparison voltage VCOMP and the system middle voltage VDD2M, is coupled to the pull-up control signal pu and pull-down control signal pd, and configured to compare the comparison voltage VCOMP with the system middle voltage VDD2M. When the voltage level of the system middle voltage VDD2M exceeds a voltage range based on the voltage level of the comparison voltage VCOMP, the bouncing-controlled circuit 120 turns on one of the P-type output transistor MP_{O} and the N-type output transistor MN_{O} through the pull-up control signal pu or the pull-down control signal pd. The voltage range is formed or defined by increasing or decreasing a desired or given voltage from the voltage level of the comparison voltage VCOMP as a reference (thereby defining a voltage band about the comparison voltage VCOMP), and the magnitude of the voltage range is relatively smaller than the difference between the system high voltage VDD2 and the system low voltage VSS2.

During boot, the system middle voltage VDD2M is equal to or about the system low voltage VSS2 and this may cause undesirable operation of the output control circuit 110 of the common voltage buffer 100. However, when the system high voltage VDD2 and the comparison voltage VCOMP are ready, through the difference between the system middle voltage VDD2M and the comparison voltage VCOMP, the bouncing-controlled circuit 120 increases the system middle voltage VDD2M and turns on the P-type output transistor MP_{O} through the pull-up control signal pu, causing the system middle voltage VDD2M to rise due to charging. In this way, the common voltage buffer 100 operate during booting.

In some example embodiments, the bouncing-controlled circuit 120 will turn on the P-type output transistor MP_{O} and begin charging the system middle voltage VDD2M, until the system middle voltage VDD2M falls within the voltage range based on the voltage level of the comparison voltage VCOMP.

On the other hand, when the system middle voltage VDD2M is equal to the system high voltage VDD2, the operation of the output control circuit 110 of the common voltage buffer 100 may be undesirable. Under the circumstances, through the difference between the system middle voltage VDD2M and the comparison voltage VCOMP, the bouncing-controlled circuit 120 decreases the system middle voltage VDD2M and turns on the N-type output transistor MN_{O} through the pull-down control signal pd, causing the system middle voltage VDD2M to begin discharging, until the system middle voltage VDD2M falls within the voltage range based on the voltage level of the comparison voltage VCOMP. Based on the above, when the system middle voltage VDD2M falls within the voltage range based on the voltage level of the comparison voltage VCOMP, the bouncing-controlled circuit 120 of the common voltage buffer 100 may not be activated and may shut down to save DC power consumption.

Moreover, the provided bouncing-controlled circuit 120 of the common voltage buffer 100 also serves as a bouncing-controller. During load transients, line transients, or bouncing periods of the system high voltage VDD2/system low voltage VSS2, the system middle voltage VDD2M may experience overshoot/undershoot. When the bouncing-controlled circuit 120 detects the voltage range based on the voltage level of the comparison voltage VCOMP, the pull-up control signal pu or the pull-down control signal pd will be correspondingly triggered to turn on one of the P-type output transistor MP_{O} and the N-type output transistor MN_{O}, so as to stabilize the system middle voltage VDD2M relatively faster, and thereby simultaneously reducing AC power consumption.

In some example embodiments, the bouncing-controlled circuit 120 includes an N-type transistor MNs and a P-type transistor MPs. The N-type transistor MNs (corresponding to the first N-type transistor) has a first terminal coupled to the pull-up control signal pu, a control terminal receiving the comparison voltage VCOMP, and a second terminal receiving the system middle voltage VDD2M. The P-type transistor MPs (corresponding to the first P-type transistor) has a first terminal receiving the system middle voltage VDD2M, a control terminal receiving the comparison voltage VCOMP, and a second terminal coupled to the pull-down control signal pd.

In some example embodiments, the voltage range based on the voltage level of the comparison voltage VCOMP is determined by the comparison voltage VCOMP, the first transistor threshold for turning on the P-type transistor MPs, and the second transistor threshold for turning on the N-type transistor MNs. In other words, the high voltage threshold (upper limit/maximum value) of the voltage range based on the voltage level of the comparison voltage VCOMP is the comparison voltage VCOMP plus the first transistor threshold for turning on the P-type transistor MPs, and the low voltage threshold (lower limit/minimum value) of the voltage range based on the voltage level of the comparison voltage VCOMP is the comparison voltage VCOMP minus the second transistor threshold.

In some example embodiments, the output control circuit 110 includes current sources I_{P} and I_{N}, P-type transistors MPi1, MPi2, MPL1, MPL2, MPc1, MPc2, MP_{FL1}, and MP_{FL2}, N-type transistors MNi1, MNi2, MNL1, MNL2, MNc1, MNc2, MN_{FL1}, and MN_{FL2}, and capacitors Cc1 and Cc2.

The current source I_{P} (corresponding to the first current source) has a first terminal coupled to the system high voltage VDD2 and a second terminal. The current source I_{N} (corresponding to the second current source) has a first terminal and a second terminal coupled to the ground voltage. The transistor MPi1 (corresponding to the second P-type transistor MPi1) has a first terminal coupled to the second terminal of the current source I_{P}, a control terminal receiving the system middle voltage VDD2M, and a second terminal. The transistor MNi1 (corresponding to the second N-type transistor) has a first terminal, a control terminal receiving the system middle voltage VDD2M, and a second terminal coupled to the first terminal of the current source I_{N}.

The transistor MNi2 (corresponding to the third N-type transistor) has a first terminal, a control terminal receiving the comparison voltage VCOMP, and a second terminal coupled to the first terminal of the current source I_{N}. The transistor MPi2 (corresponding to the third P-type transistor) has a first terminal coupled to the second terminal of the current source I_{P}, a control terminal receiving the comparison voltage VCOMP, and a second terminal. The transistor MPL1 (corresponding to the fourth P-type transistor) has a first terminal receiving the system high voltage VDD2, a control terminal, and a second terminal coupled to the first terminal of the N-type transistor MNi1. The transistor MPL2 (corresponding to the fifth P-type transistor) has a first terminal receiving the system high voltage VDD2, a control terminal coupled to the control terminal of the P-type transistor MPL1, and a second terminal coupled to the first terminal of the N-type transistor MNi2.

The P-type transistor MPc1 (corresponding to the sixth P-type transistor) has a first terminal coupled to the second terminal of the P-type transistor MPL1, a control terminal receiving the bias VB2 (corresponding to the first bias), and a second terminal coupled to the control terminal of the P-type transistor MPL1. The transistor MPc2 (corresponding to the seventh P-type transistor) has a first terminal coupled to the second terminal of the P-type transistor MPL2, a control terminal receiving the bias VB2, and a second terminal providing the pull-up control signal pu. The transistor MN_{FL1} (corresponding to the fourth N-type transistor) has a first terminal coupled to the second terminal of the P-type transistor MPc1, a control terminal receiving the bias VC3 (corresponding to the second bias), and a second terminal.

The P-type transistor MP_{FL1} (corresponding to the eighth P-type transistor) has a first terminal coupled to the second terminal of the P-type transistor MPc1, a control terminal receiving the bias VC2 (corresponding to the third bias), and a second terminal coupled to the second terminal of the N-type transistor MN_{FL1}. The transistor MN_{FL2} (corresponding to the fifth N-type transistor) has a first terminal coupled to the second terminal of the P-type transistor MPc2, a control terminal receiving the bias VC4 (corresponding to the fourth bias), and a second terminal providing the pull-down control signal pd. The transistor MP_{FL2} (corresponding to the ninth P-type transistor) has a first terminal coupled to the second terminal of the P-type transistor MPc2, a control terminal receiving the bias VC1 (corresponding to the fifth bias), and a second terminal coupled to the second terminal of the N-type transistor MN_{FL2}.

The N-type transistor MNc1 (corresponding to the sixth N-type transistor) has a first terminal coupled to the second terminals of the N-type transistor MN_{FL1}, a control terminal receiving the bias VB3 (corresponding to the sixth bias), and a second terminal coupled to the second terminal of the P-type transistor MPi1. The N-type transistor MNc2 (corresponding to the seventh N-type transistor) has a first terminal coupled to the second terminal of the N-type transistor MN_{FL2}, a control terminal receiving the bias VB3, and a second terminal coupled to the second terminal of the P-type transistor MPi2. The N-type transistor MNL1 (corresponding to the eighth N-type transistor MNL1) has a first terminal coupled to the second terminal of the N-type transistor MNc1, a control terminal coupled to the second terminal of the N-type transistor MN_{FL1}, and a second terminal receiving the system low voltage VSS2.

The transistor MNL2 (corresponding to the ninth N-type transistor) has a first terminal coupled to the second terminal of the N-type transistor MNc2, a control terminal coupled to the control terminal of the N-type transistor MNL1, and a second terminal receiving the system low voltage VSS2. The capacitor Cc1 (corresponding to the first capacitor) is coupled between the second terminal of the P-type transistor MPL2 and the system middle voltage VDD2M. The capacitor Cc2 (corresponding to the second capacitor) is coupled between the system middle voltage VDD2M and the second terminal of the seventh N-type transistor MNc2.

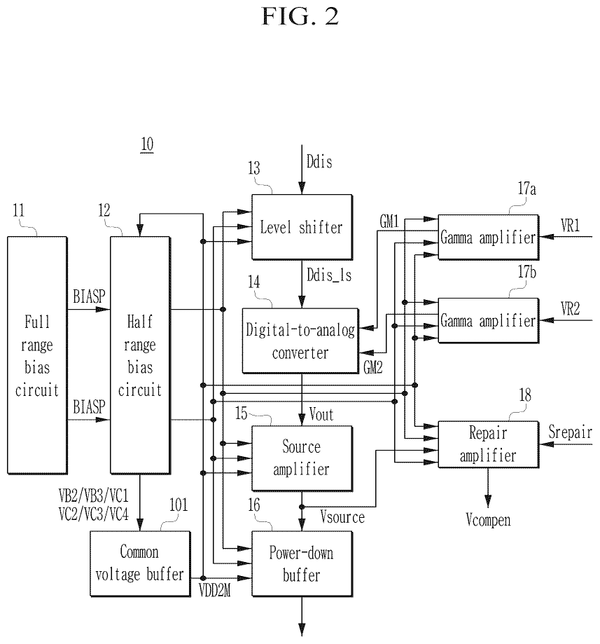

FIG. 2 is a system diagram of a source driver 10 according to some example embodiments. Referring to FIG. 1 and FIG. 2, the source driver 10 includes a full range bias circuit 11, a half range bias circuit 12, a level shifter 13, a digital-to-analog converter 14, a source amplifier 15, a power-down buffer 16, multiple gamma amplifiers 17a to 17b, a repair amplifier 18, and a common voltage buffer 101. The full range bias circuit 11 is designed to generate/provide a positive global bias BIASP and a negative global bias BIASN. The half range bias circuit 12 generates/provides biases VB1 to VB4 and VC1 to VC4 to provide bias current for analog sub-circuits, such as the common voltage buffer 101, the level shifter 13, the source amplifier 15, the power-down buffer 16, the multiple gamma amplifiers 17a to 17b, and the repair amplifier 18. When the common voltage buffer 101 is turned on, the system middle voltage VDD2M is fed back to the half range bias circuit 12, and the common voltage buffer 101 may refer to the common voltage buffer 100, but example embodiments are not limited thereto.

According to some example embodiments, the half range bias circuit 12 is coupled to the full range bias circuit 11 and the common voltage buffer 101 to receive the positive global bias BIASP, the negative global bias BIASN, and the system middle voltage VDD2M, and provides biases VB1 to VB4 and VC1 to VC4 based on the positive global bias BIASP, the negative global bias BIASN, and the system middle voltage VDD2M, wherein biases VB1, VB4, (corresponding to the first operation bias and the second operation bias), biases VB2, VB3, and VC1 to VC4 are provided to the level shifter 13, the source amplifier 15, the power-down buffer 16, the multiple gamma amplifiers 17a to 17b, the repair amplifier 18, and the common voltage buffer 101.

The level shifter 13 is coupled to the half range bias circuit 12 and the common voltage buffer 101 to receive biases VB1, VB4 and the system middle voltage VDD2M, and receives display data Ddis, to perform operations based on biases VB1, VB4 and the system middle voltage VDD2M, and provides shift display data Ddis_ls. The gamma amplifiers 17a to 17b are coupled to the half range bias circuit 12 and the common voltage buffer 101 to receive biases VB1, VB4 and the system middle voltage VDD2M, and receive a corresponding reference voltage (such as VR1 to VR2) separately, wherein the gamma amplifiers 17a to 17b perform operations based on biases VB1, VB4 and the system middle voltage VDD2M, and provide corresponding gamma voltages (such as GM1 to GM2) separately.

The digital-to-analog converter 14 is coupled to the level shifter 13 and the gamma amplifiers 17a to 17b to provide the output gamma voltage Vout based on the shift display data Ddis_ls and the gamma voltages GM1 to GM2 provided by the gamma amplifiers 17a to 17b. The source amplifier 15 is coupled to the digital-to-analog converter 14, the half range bias circuit 12, and the common voltage buffer 101 to receive biases VB1, VB4, and the system middle voltage VDD2M, and performs operations based on biases VB1, VB4, and the system middle voltage VDD2M, wherein the source amplifier 15 provides the source voltage Vsource based on the output gamma voltage Vout.

The power-down buffer 16 is coupled to the source amplifier 15, the half range bias circuit 12, and the common voltage buffer 101 to receive biases VB1, VB4, and the system middle voltage VDD2M, and performs operations based on biases VB1, VB4, and the system middle voltage VDD2M, and determines whether to output the source voltage Vsource based on the system power supply status of the source driver 10. The repair amplifier 18 is coupled to the source amplifier 15, the half range bias circuit 12, and the common voltage buffer 101, and receives a repair signal Srepair, so as to receive biases VB1, VB4, and the system middle voltage VDD2M, and performs operations based on biases VB1, VB4, and the system middle voltage VDD2M, and determines whether to provide a compensation voltage Vcompen corresponding to the source voltage Vsource based on the repair signal Srepair.

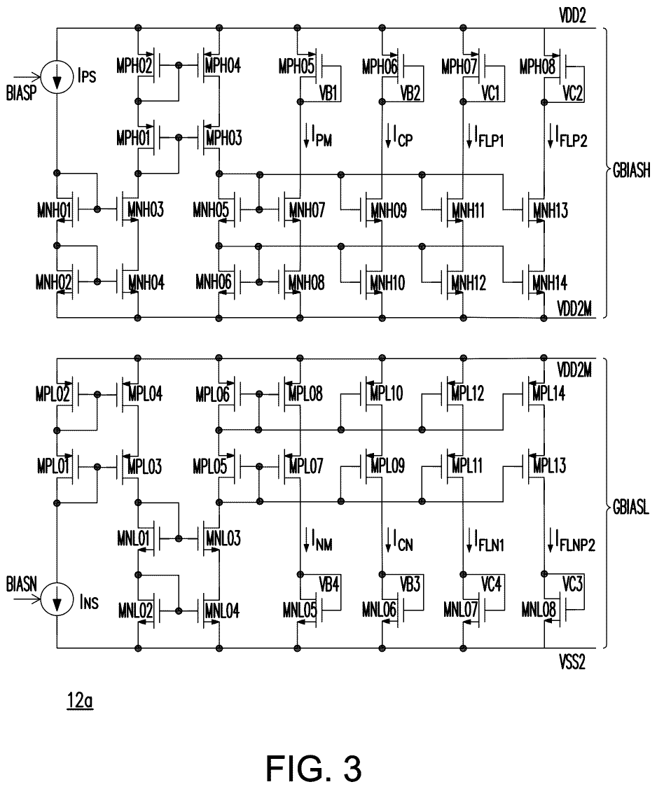

FIG. 3 is a circuit diagram of a half range bias circuit 12a according to some example embodiments. Referring to FIG. 1 to FIG. 3, the half range bias circuit 12 is illustrated as the half range bias circuit 12a, and the half range bias circuit 12a includes, for example, a high voltage terminal bias circuit GBIASH and a low voltage terminal bias circuit GBIASL. The high voltage terminal bias circuit GBIASH receives a positive global bias BIASP to provide biases VB1, VB2, VC2, and VC1. The low voltage terminal bias circuit GBIASL receives a negative global bias BIASN to provide biases VB4, VC3, VC4, and VB3.

In some example embodiments, the high voltage terminal bias circuit GBIASH includes a current source I_{PS}, P-type transistors MPH01 to MPH08, and N-type transistors MNH01 to MNH14. The current source I_{PS} (corresponding to the third current source) has a first terminal coupled to the system high voltage VDD2 and a second terminal, and receives the positive global bias BIASP. The transistor MNH01 (corresponding to the tenth N-type transistor) has a first terminal coupled to the second terminal of the current source I_{PS}, a control terminal coupled to the first terminal of the N-type transistor MNH01, and a second terminal. The transistor MNH03 (corresponding to the eleventh N-type transistor) has a first terminal, a control terminal coupled to the control terminal of the N-type transistor MNH01, and a second terminal.

The N-type transistor MNH02 (the twelfth N-type transistor) has a first terminal coupled to the second terminal of the N-type transistor MNH01, a control terminal coupled to the first terminal of the N-type transistor MNH02, and a second terminal receiving the system middle voltage VDD2M. The transistor MNH04 (corresponding to the thirteenth N-type transistor) has a first terminal coupled to the second terminal of the N-type transistor MNH03, a control terminal coupled to the control terminal of the N-type transistor MNH02, and a second terminal receiving the middle voltage VDD2M.

The transistor MPH02 (corresponding to the tenth P-type transistor) has a first terminal receiving the system high voltage VDD2, a control terminal, and a second terminal coupled to the control terminal of the P-type transistor MPH02. The P-type transistor MPH04 (corresponding to the eleventh P-type transistor) has a first terminal receiving the system high voltage VDD2, a control terminal coupled to the control terminal of the P-type transistor MPH02, and a second terminal. The P-type transistor MPH01 (corresponding to the twelfth P-type transistor) has a first terminal coupled to the second terminal of the P-type transistor MPH02, a control terminal, and a second terminal coupled to the control terminal of the P-type transistor MPH01 and coupled to the first terminal of the N-type transistor MNH03. The P-type transistor MPH03 (corresponding to the thirteenth P-type transistor) has a first terminal coupled to the second terminal of the P-type transistor MPH04, a control terminal coupled to the control terminal of the P-type transistor MPH01, and a second terminal.

The N-type transistor MNH05 (corresponding to the fourteenth N-type transistor) has a first terminal coupled to the second terminal of the P-type transistor MPH03, a control terminal coupled to the first terminal of the N-type transistor MNH05, and a second terminal. The transistor MNH07 (corresponding to the fifteenth N-type transistor) has a first terminal, a control terminal coupled to the control terminal of the N-type transistor MNH05, and a second terminal. The N-type transistor MNH06 (corresponding to the sixteenth N-type transistor) has a first terminal coupled to the second terminal of the N-type transistor MNH05, a control terminal coupled to the first terminal of the N-type transistor MNH06, and a second terminal receiving the middle voltage VDD2M.

The transistor MNH08 (corresponding to the seventeenth N-type transistor) has a first terminal coupled to the second terminal of the N-type transistor MNH07, a control terminal coupled to the control terminal of the N-type transistor MNH06, and a second terminal receiving the middle voltage VDD2M. The P-type transistor MPH05 (corresponding to the fourteenth P-type transistor) has a first terminal receiving the system high voltage VDD2, a control terminal providing the bias VB1, and a second terminal coupled to the control terminal of the P-type transistor MPH05 and the first terminal of the N-type transistor MNH07.

The N-type transistor MNH09 (corresponding to the eighteenth N-type transistor) has a first terminal, a control terminal coupled to the control terminal of the N-type transistor MNH05, and a second terminal. The N-type transistor MNH10 (corresponding to the nineteenth N-type transistor) has a first terminal coupled to the second terminal of the N-type transistor MNH09, a control terminal coupled to the control terminal of the N-type transistor MNH06, and a second terminal receiving the middle voltage VDD2M. The P-type transistor MPH06 (corresponding to the fifteenth P-type transistor) has a first terminal receiving the system high voltage VDD2, a control terminal providing the bias VB2, and a second terminal coupled to the control terminal of the P-type transistor MPH06 and the first terminal of the N-type transistor MNH09.

The N-type transistor MNH11 (corresponding to the twentieth N-type transistor) has a first terminal, a control terminal coupled to the control terminal of the N-type transistor MNH05, and a second terminal. The N-type transistor MNH12 (corresponding to the twenty-first N-type transistor) has a first terminal coupled to the second terminal of the N-type transistor MNH11, a control terminal coupled to the control terminal of the N-type transistor MNH06, and a second terminal receiving the middle voltage VDD2M. The P-type transistor MPH07 (corresponding to the sixteenth P-type transistor) has a first terminal receiving the system high voltage VDD2, a control terminal providing the bias VC1, and a second terminal coupled to the control terminal of the P-type transistor MPH07 and the first terminal of the N-type transistor MNH11.

The N-type transistor MNH13 (corresponding to the twenty-second N-type transistor) has a first terminal, a control terminal coupled to the control terminal of the N-type transistor MNH05, and a second terminal. The N-type transistor MNH14 (the twenty-third N-type transistor) has a first terminal coupled to the second terminal of the N-type transistor MNH13, a control terminal coupled to the control terminal of the N-type transistor MNH06, and a second terminal receiving the middle voltage VDD2M. The P-type transistor MPH08 (corresponding to the seventeenth P-type transistor) has a first terminal receiving the system high voltage VDD2, a control terminal providing the bias VC2, and a second terminal coupled to the control terminal of the P-type transistor MPH08 and the first terminal of the N-type transistor MNH13.

In some example embodiments, the low voltage terminal bias circuit GBIASL includes the current source I_{NS}, P-type transistors MPL01 to MPH14, and N-type transistors MNL01 to MNL08. The current source I_{NS} (corresponding to the fourth current source) has a first terminal and a second terminal coupled to the system low voltage VSS2, and receives the negative global bias BIASN.

The P-type transistor MPL02 (corresponding to the eighteenth P-type transistor) has a first terminal receiving the system middle voltage VDD2M, a control terminal, and a second terminal coupled to the control terminal of the P-type transistor MPL02. The P-type transistor MPL04 (corresponding to the nineteenth P-type transistor) has a first terminal receiving the system middle voltage VDD2M, a control terminal coupled to the control terminal of the P-type transistor MPL02, and a second terminal. The P-type transistor MPL01 (corresponding to the twentieth P-type transistor) has a first terminal coupled to the second terminal of the P-type transistor MPL02, a control terminal, and a second terminal coupled to the control terminal of the P-type transistor MPL01 and coupled to the first terminal of the current source I_{NS}. The P-type transistor MPL03 (corresponding to the twenty-first P-type transistor) has a first terminal coupled to the second terminal of the P-type transistor MPL04, a control terminal coupled to the control terminal of the P-type transistor MPL01, and a second terminal.

The N-type transistor MNL01 (corresponding to the twenty-fourth N-type transistor) has a first terminal coupled to the second terminal of the P-type transistor MPL03, a control terminal coupled to the first terminal of the N-type transistor MNL01, and a second terminal. The N-type transistor MNL03 (corresponding to the twenty-fifth N-type transistor) has a first terminal, a control terminal coupled to the control terminal of the N-type transistor MNL01, and a second terminal. The N-type transistor MNL02 (corresponding to the twenty-sixth N-type transistor) has a first terminal coupled to the second terminal of the N-type transistor MNL01, a control terminal coupled to the first terminal of the N-type transistor MNL02, and a second terminal receiving the system low voltage VSS2. The N-type transistor MNL04 (corresponding to the twenty-seventh N-type transistor) has a first terminal coupled to the second terminal of the N-type transistor MNL03, a control terminal coupled to the control terminal of the N-type transistor MNL02, and a second terminal receiving the system low voltage VSS2.

The P-type transistor MPL06 (corresponding to the twenty-second P-type transistor) has a first terminal receiving the system middle voltage VDD2M, a control terminal, and a second terminal coupled to the control terminal of the P-type transistor MPL06. The P-type transistor MPL08 (corresponding to the twenty-third P-type transistor) has a first terminal receiving the system middle voltage VDD2M, a control terminal coupled to the control terminal of the P-type transistor MPL06, and a second terminal. The P-type transistor MPL05 (corresponding to the twenty-fourth P-type transistor) has a first terminal coupled to the second terminal of the P-type transistor MPL06, a control terminal, and a second terminal coupled to the control terminal of the P-type transistor MPL05 and coupled to the first terminal of the N-type transistor MNL03. The P-type transistor MPL07 (corresponding to the twenty-fifth P-type transistor) has a first terminal coupled to the second terminal of the P-type transistor MPL08, a control terminal coupled to the control terminal of the P-type transistor MPL05, and a second terminal. The N-type transistor MNL05 (corresponding to the twenty-eighth N-type transistor) has a first terminal coupled to the second terminal of the P-type transistor MPL07, a control terminal coupled to the first terminal of the N-type transistor MNL05 and providing bias VB4, and a second terminal receiving the system low voltage VSS2.

The P-type transistor MPL10 (corresponding to the twenty-sixth P-type transistor) has a first terminal receiving the system middle voltage VDD2M, a control terminal coupled to the control terminal of the P-type transistor MPL06, and a second terminal. The P-type transistor MPL09 (corresponding to the twenty-seventh P-type transistor) has a first terminal coupled to the second terminal of the P-type transistor MPL10, a control terminal coupled to the control terminal of the P-type transistor MPL05, and a second terminal. The N-type transistor MNL06 (corresponding to the twenty-ninth N-type transistor) has a first terminal coupled to the second terminal of the P-type transistor MPL09, a control terminal coupled to the first terminal of the N-type transistor MNL06 and providing bias VB3, and a second terminal receiving the system low voltage VSS2.

The P-type transistor MPL12 (corresponding to the twenty-eighth P-type transistor) has a first terminal receiving the system middle voltage VDD2M, a control terminal coupled to the control terminal of the P-type transistor MPL06, and a second terminal. The P-type transistor MPL11 (corresponding to the twenty-ninth P-type transistor) has a first terminal coupled to the second terminal of the P-type transistor MPL12, a control terminal coupled to the control terminal of the P-type transistor MPL05, and a second terminal. The N-type transistor MNL07 (corresponding to the thirtieth N-type transistor) has a first terminal coupled to the second terminal of the P-type transistor MPL11, a control terminal coupled to the first terminal of the N-type transistor MNL07 and providing bias VC4, and a second terminal receiving the system low voltage VSS2.

The P-type transistor MPL14 (corresponding to the thirtieth P-type transistor) has a first terminal receiving the system middle voltage VDD2M, a control terminal coupled to the control terminal of the P-type transistor MPL06, and a second terminal. The P-type transistor MPL13 (corresponding to the thirty-first P-type transistor) has a first terminal coupled to the second terminal of the P-type transistor MPL14, a control terminal coupled to the control terminal of the P-type transistor MPL05, and a second terminal. The N-type transistor MNL08 (corresponding to the thirty-first N-type transistor) has a first terminal coupled to the second terminal of the P-type transistor MPL13, a control terminal coupled to the first terminal of the N-type transistor MNL08 and providing bias VC3, and a second terminal receiving the system low voltage VSS2.

According to some example embodiments, the maximum operating voltage VDD2M_{MAX} of the system middle voltage VDD2M is limited by the high voltage terminal bias circuit GBIASH. The maximum operating voltage VDD2M_{MAX} may be expressed as:

VDD2−VDD2M_{MAX}>V_{SG_MPH01}+V_{SG_MPH02}+V_{DS_MNH03}+V_{DS_MNH04} (Equation 1)

VDD2 is the voltage level of the system high voltage VDD2, V_{SG_MPH01} is the source-gate voltage (i.e., the voltage across the first terminal and the control terminal of transistor MPH01) of the transistor MPH01, V_{SG_MPH02} is the source-gate voltage (i.e., the voltage across the first terminal and the control terminal of transistor MPH02) of the transistor MPH02, V_{DS_MNH03} is the source-drain voltage (i.e., the voltage across the first terminal and the second terminal of transistor MNH03) of the transistor MNH03, V_{DS_MNH04} is the source-drain voltage (i.e., the voltage across the first terminal and the second terminal of transistor MNH04) of the transistor MNH04. As the system middle voltage VDD2M exceeds the maximum operating voltage VDD2M_{MAX}, and the biases VB1, VB2, VC1 and VC2 are close to the system high voltage VDD2, the high voltage terminal bias circuit GBIASH will not be able to operate, resulting in reduced bias current in the high voltage terminal bias circuit GBIASH.

According to some example embodiments, the minimum operating voltage VDD2M_{MIN} of the system middle voltage VDD2M is limited by the low voltage terminal bias circuit GBIASL. The minimum operating voltage VDD2M_{MIN} may be expressed as:

VDD2M_{MIN}>V_{SG_MPL05}+V_{SG_MPL06}+V_{DS_MNL03}+V_{DS_MNL04} (Equation 2)

V_{SG_MPL05} is the source-gate voltage (i.e., the voltage across the first terminal and the control terminal of transistor MPL05) of the transistor MPL05, V_{SG_MPL06} is the source-gate voltage (i.e., the voltage across the first terminal and the control terminal of transistor MPL06) of the transistor MPL06, V_{DS_MNL03} is the drain-source voltage (i.e., the voltage across the first terminal and the second terminal of transistor MNL03) of the transistor MNL03, V_{DS_MNL04} is the drain-source voltage (i.e., the voltage across the first terminal and the second terminal of transistor MNL04) of the transistor MNL04. As the system middle voltage VDD2M becomes less than the minimum operating voltage VDD2M_{MIN}, the low voltage terminal bias circuit GBIASL will stop working, and because the biases VB4, VB3, VC4 and VC3 are close to the system low voltage VSS2, there is reduced bias current in the low voltage terminal bias circuit GBIASL.

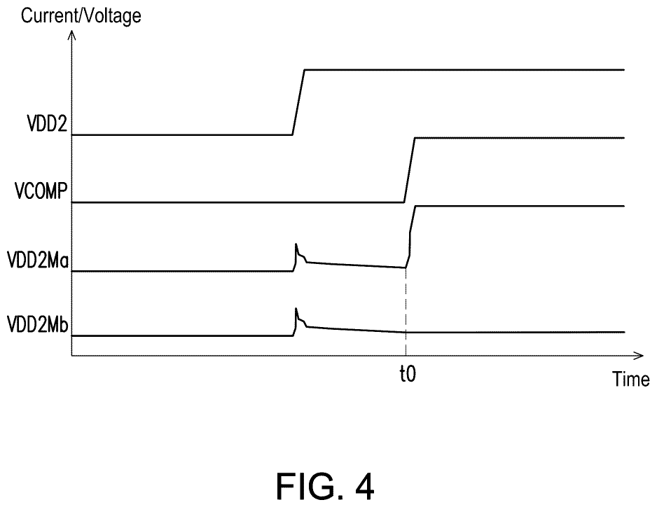

FIG. 4 illustrates a boot simulation waveform diagram of common voltage buffers with and without bouncing-controlled circuits. Referring to FIG. 1 to FIG. 4, the waveform VDDMa illustrates the boot simulation waveform of a common voltage buffer (such as 100, 101) with a bouncing-controlled circuit (such as 120), and waveform VDDMb illustrates the boot simulation waveform of a common voltage buffer (such as 100, 101) without a bouncing-controlled circuit (such as 120).

According to some example embodiments, the system high voltage VDD2 and the comparison voltage VCOMP are assumed as 18 volts (V) and 9V, respectively. The rising time (TR) of the system high voltage VDD2 and the comparison voltage VCOMP is approximately equal to 1 millisecond (ms). According to the simulation results shown in FIG. 4, the common voltage buffer (such as 100, 101) without a bouncing-controlled circuit (such as 120) is unable to generate the power supply of the system middle voltage VDD2M, because when the system middle voltage VDD2M is close to the system low voltage VSS2, the output control circuit 110 alone is unable to activate the common voltage buffer (such as 100, 101) to begin working, and after time t0, it is challenging for the common voltage buffer (such as 100, 101) to boot. On the other hand, as shown in FIG. 4, the common voltage buffer (such as 100, 101), according to some example embodiments, with a bouncing-controlled circuit (such as 120) performs boot operation with just one N-type transistor MNs.

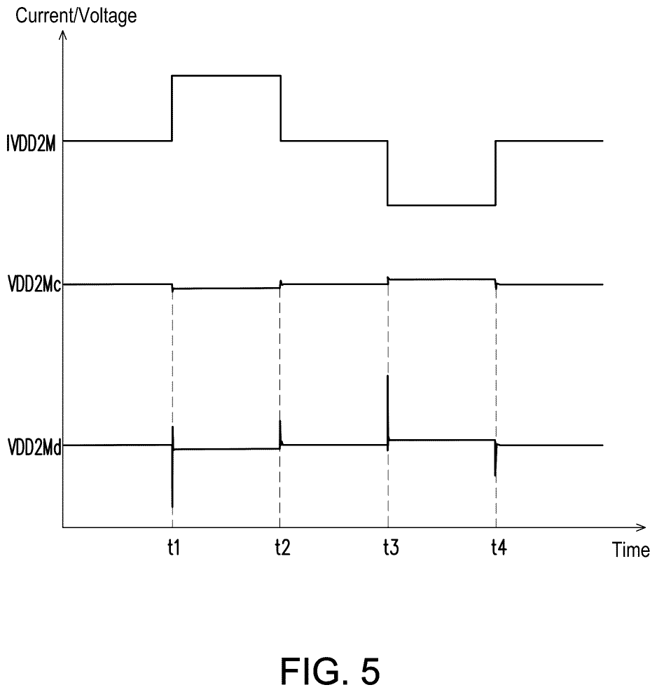

FIG. 5 illustrates a load transient simulation waveform diagram of common voltage buffers with and without bouncing-controlled circuits. Referring to FIG. 1 to FIG. 3 and FIG. 4, according to some example embodiments, the waveform VDDMc illustrates the load transient simulation waveform of a common voltage buffer (such as 100, 101) with a bouncing-controlled circuit (such as 120), and the waveform VDDMd illustrates the load transient simulation waveform of a common voltage buffer (such as 100, 101) without a bouncing-controlled circuit (such as 120).

According to some example embodiments, it is assumed that the rising time and falling time of the output current IVDD2M of the system middle voltage VDD2M is approximately 10 nanoseconds (ns), and the maximum charging current and maximum discharging current of the output current IVDD2M is approximately 10 milliamperes (mA). According to the simulation results shown in FIG. 5, as shown at times t1 to t4, the maximum overshoot/undershoot of the common voltage buffer (such as 100, 101) without a bouncing-controlled circuit (such as 120) is approximately 1.5V. In contrast, by using the bouncing-controlled circuit (such as 120), the maximum overshoot/undershoot is reduced from 1.5V to 170 millivolts (mV). The common voltage buffer (such as 100, 101) according to some example embodiments with a bouncing-controlled circuit (such as 120) may reduce overshoot/undershoot and also lower AC power consumption.

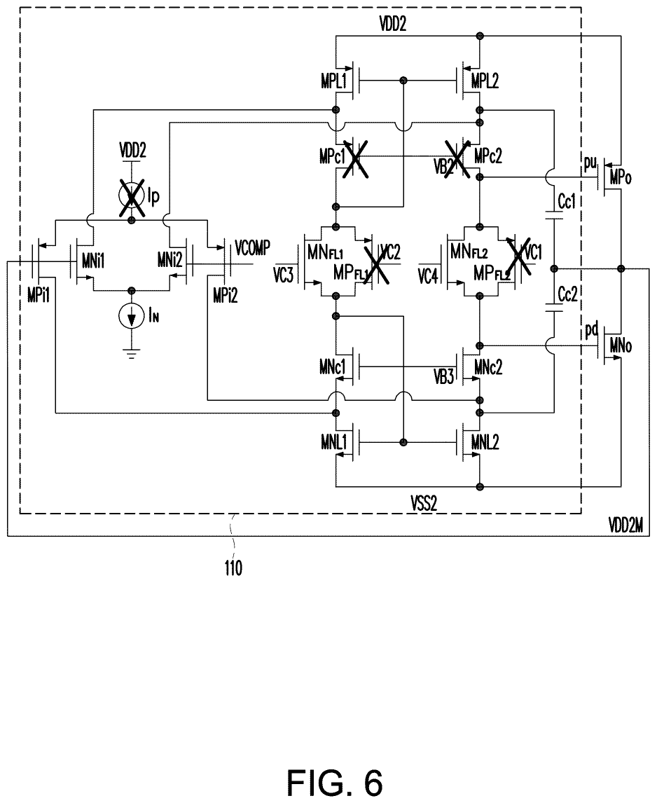

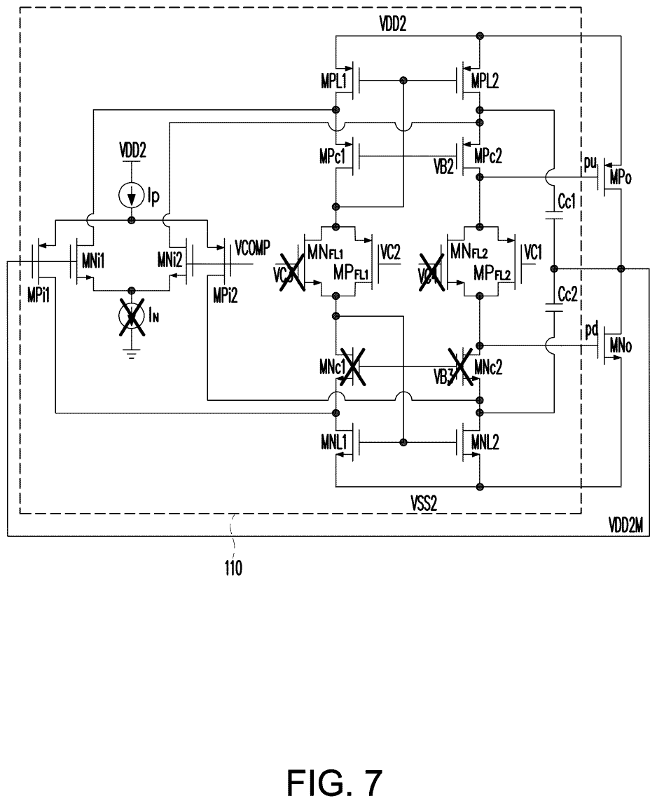

FIG. 6 illustrates an operation diagram of a common voltage buffer without a bouncing-controlled circuit when the system middle voltage is higher than the maximum value. FIG. 7 illustrates an operation diagram of a common voltage buffer without a bouncing-controlled circuit when the system middle voltage is lower than the minimum value. Referring to FIG. 1 to FIG. 3, FIG. 6, and FIG. 7, the operation of the common voltage buffer (such as 100, 101) without a bouncing-controlled circuit (such as 120) is the same as a conventional common voltage buffer based on a class AB push-pull amplifier.

Transistors MPi1, MPi2, MNi1 and MNi2 serve as the input pair of a full range folded cascode amplifier, with their bias current defined by current sources I_{P} and I_{N}. Transistors MPL1, MPL2, MNL1 and MNL2 are active loads, with their bias current defined by floating bias (corresponding to currents I_{FLP1}, I_{FLN1}, I_{FLP2} and I_{FLN2} provided by transistors MPH07, MPH08, MNL07 and MNL08). The cascode stage is designed using transistors MPC1, MPC2, MNC1 and MNC2. To further ensure stability, capacitors C_{C}1 and C_{C}2 are introduced to compensate for AC performance. The P-type output transistor MP_{O} and the N-type output transistor MN_{O} are configured to drive the system middle voltage VDD2M. Biases VB2, VC1, VC2 and current I_{PM} provided by the transistor MPH05 are current/voltage generated through mirroring in the high voltage terminal bias circuit GBIASH, and biases VB3, VC4, VC3 and current I_{NM} provided by the transistor MNL05 are current/voltage generated through mirroring in the low voltage terminal bias circuit GBIASL.

In conventional common voltage buffer based on a class AB push-pull amplifier, a dynamic range of system middle voltage VDD2M is limited, as shown in Equation 1 and Equation 2. When the system middle voltage VDD2M is greater than the maximum operating voltage VDD2M_{MAX}, the high voltage terminal bias circuit GBIASH does not function, currents I_{PM}, I_{FLP1} and I_{FLP2} decrease, and the bias VB2 is close to the system high voltage VDD2. The equivalent circuit of a conventional common voltage buffer operating at system middle voltage VDD2M greater than the maximum operating voltage VDD2M_{MAX} is shown in FIG. 6. Since there is no current in the cascode stage, the conventional common voltage buffer cannot operate. Furthermore, when the system middle voltage VDD2M is greater than the maximum operating voltage VDD2M_{MAX}, the system middle voltage VDD2M is in a floating state.

On the other hand, when the system middle voltage VDD2M is lower than the minimum operating voltage VDD2M_{MIN}, the low voltage terminal bias circuit GBIASL does not function, the currents I_{NM}, I_{FLN1} and I_{FLN2} decrease, and the bias VB3 is close to the system low voltage VSS2. The equivalent circuit of a conventional common voltage buffer operating at the system middle voltage VDD2M lower than the minimum operating voltage VDD2M_{MIN} is shown in FIG. 7. Since there is no current in the cascode stage, the conventional common voltage buffer is unable to operate. Because the low voltage terminal bias circuit GBIASL does not function during the period when the voltage level of the system middle voltage VDD2M is too low, the system middle voltage VDD2M is unable to rise from the system low voltage VSS2, the conventional common voltage buffer has reduced performance during boot operation.

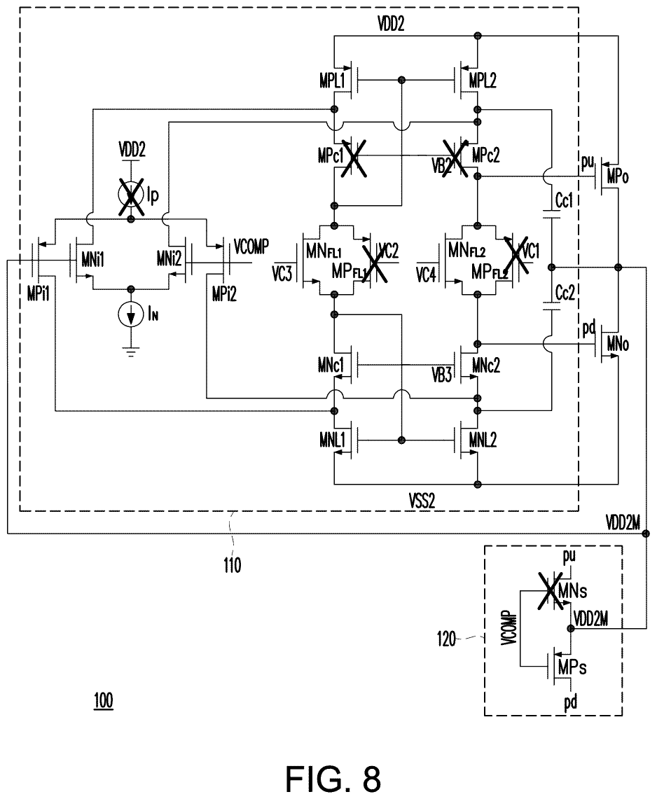

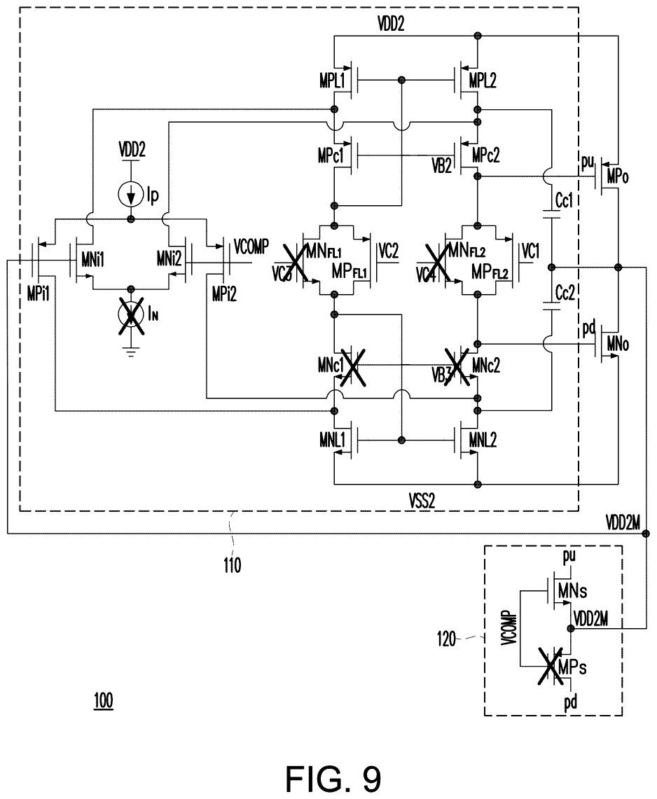

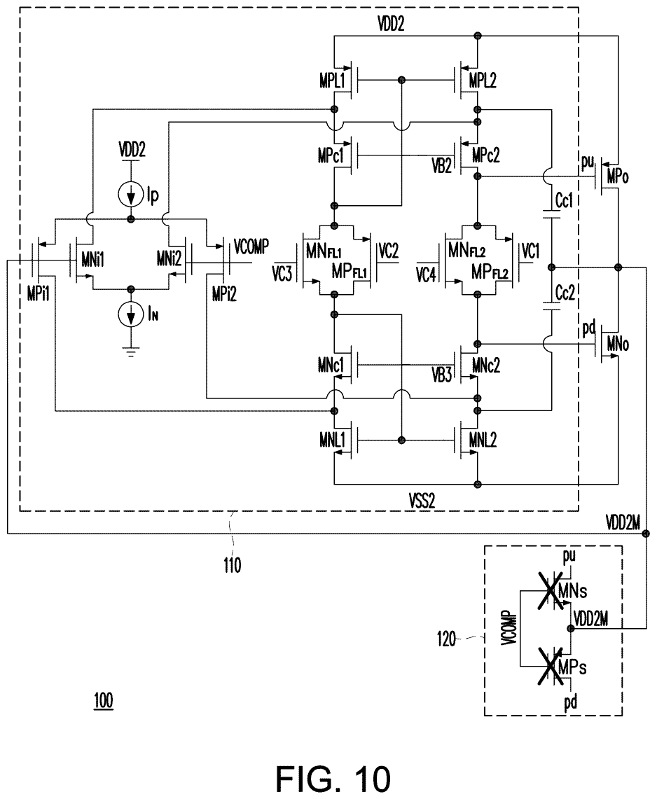

FIG. 8 illustrates an operation diagram of a common voltage buffer with a bouncing-controlled circuit when the system middle voltage is higher than the high voltage threshold of the voltage range. FIG. 9 illustrates an operation diagram of a common voltage buffer with a bouncing-controlled circuit when the system middle voltage is lower than the low voltage threshold of the voltage range. FIG. 10 illustrates an operation diagram of a common voltage buffer with a bouncing-controlled circuit when the system middle voltage is within the voltage range. Referring to FIG. 1 to FIG. 3, and FIG. 6 to FIG. 10, according to some example embodiments, in order to address the limitations due to the high voltage terminal bias circuit GBIASH and the low voltage terminal bias circuit GBIASL transistors MNs and MPs (such as the bouncing-controlled circuit 120) are used for the bouncing-controlled circuit 120 that is used for bouncing-controlling of the system middle voltage VDD2M and the boot of the common voltage buffer (such as 100, 101), as shown in FIG. 1.

Upon power readiness, when the system middle voltage VDD2M is greater than the maximum operating voltage VDD2M_{MAX}, the currents I_{PM}, I_{CP}, I_{FLP1}, and I_{FLP2} are 0 ampere (A) during the period in which the system high voltage VDD2 and system middle voltage VDD2M are operational. Then, because the system middle voltage VDD2M-comparison voltage VCOMP>first transistor threshold V_{TH_MPS} (the system middle voltage VDD2M is higher than the high voltage threshold), the P-type transistor MPs is turned on. The P-type transistor MPs raises the voltage level of the pull-down control signal pd, which in turn activates the N-type output transistor MN_{O} and begins to discharge the system middle voltage VDD2M. FIG. 8 illustrates the operation of the common voltage buffer 100 with the bouncing-controlled circuit 120 during the period when the system middle voltage VDD2M is greater than the maximum operating voltage VDD2M_{MAX} and the system middle voltage VDD2M-comparison voltage VCOMP>first transistor threshold V_{TH_MPS}. When the system middle voltage VDD2M is less than the maximum operating voltage VDD2M_{MAX} and the system middle voltage VDD2M-comparison voltage VCOMP<first transistor threshold V_{TH_MPS} (the system middle voltage VDD2M is within the voltage range), the common voltage buffer 100 operates in a manner similar to an ordinary class AB push-pull amplifier. Then, the P-type transistor is turned off to reduce DC power consumption, as shown in FIG. 10.

Upon power readiness, when the system middle voltage VDD2M is less than the minimum operating voltage VDD2M_{MIN}, the currents I_{NM}, I_{CN}, I_{FLN1}, and I_{FLN2} are 0 ampere (A) during the period in which the system high voltage VDD2 and system middle voltage VDD2M are operational. Then, because the comparison voltage VCOMP-system middle voltage VDD2M>second transistor threshold V_{TH_MNS} (the system middle voltage VDD2M is lower than the low voltage threshold), the N-type transistor MNs is turned on. The N-type transistor MNs pulls down the pull-up control signal pu, which in turn activates the P-type output transistor MP_{O} and begins to charge the system middle voltage VDD2M. FIG. 9 illustrates the operation of the common voltage buffer 100 with the bouncing-controlled circuit 120 during the period when the system middle voltage VDD2M is less than the minimum operating voltage VDD2M_{MIN} and the comparison voltage VCOMP-system middle voltage VDD2M>second transistor threshold V_{TH_MNS}. When the system middle voltage VDD2M is larger than the minimum operating voltage VDD2M_{MIN} and the comparison voltage VCOMP-system middle voltage VDD2M<second transistor threshold V_{TH_MNS} (that is, the system middle voltage VDD2M is within the voltage range), the common voltage buffer 100 operates in a manner similar to an ordinary class AB push-pull amplifier. Then, the N-type transistor MNs is turned off to reduce DC power consumption, as shown in FIG. 10. Based on the above, the common voltage buffer 100 performs boot operation when the system middle voltage VDD2M is equal to the system low voltage VSS2 without using the bouncing-controlled circuit 120 provided in the present disclosure.

In some example embodiments, the N-type transistor MNs and P-type transistor MPs may also be used as bouncing-controllers to reduce the overshoot/undershoot of the system middle voltage VDD2M during load transients, line transients, or bouncing period of the system high voltage VDD2. Under the condition where the system middle voltage VDD2M>comparison voltage VCOMP+first transistor threshold V_{TH_MPS}, the P-type transistor MPs is turned on to raise the pull-down control signal pd, which in turn activates the N-type output transistor MN_{O} to immediately begin discharging the system middle voltage VDD2M until the system middle voltage VDD2M<comparison voltage VCOMP+first transistor threshold V_{TH_MPS}.

Relatively speaking, under the condition where the system middle voltage VDD2M<comparison voltage VCOMP-second transistor threshold V_{TH_MNS}, the N-type transistor MNs is turned on to pull down the pull-up control signal pu, which in turn activates the P-type output transistor MP_{O} to begin charging (e.g., within a short time) the system middle voltage VDD2M until the system middle voltage VDD2M>comparison voltage VCOMP-second transistor threshold V_{TH_MNS}. Therefore, the overshoot/undershoot of the system middle voltage VDD2M is limited by the threshold voltages (e.g., the first transistor threshold V_{TH_MPS} and the second transistor threshold V_{TH_MNS}) of the N-type transistor MNs and P-type transistor MPs. Since the overshoot/undershoot is limited, the AC power consumption may be reduced. As shown in FIG. 10, during the period when comparison voltage VCOMP-second transistor threshold V_{TH_MNS}<system middle voltage VDD2M<comparison voltage VCOMP+first transistor threshold V_{TH_MPS}, both the N-type transistor MNs and P-type transistor MPs are turned off.

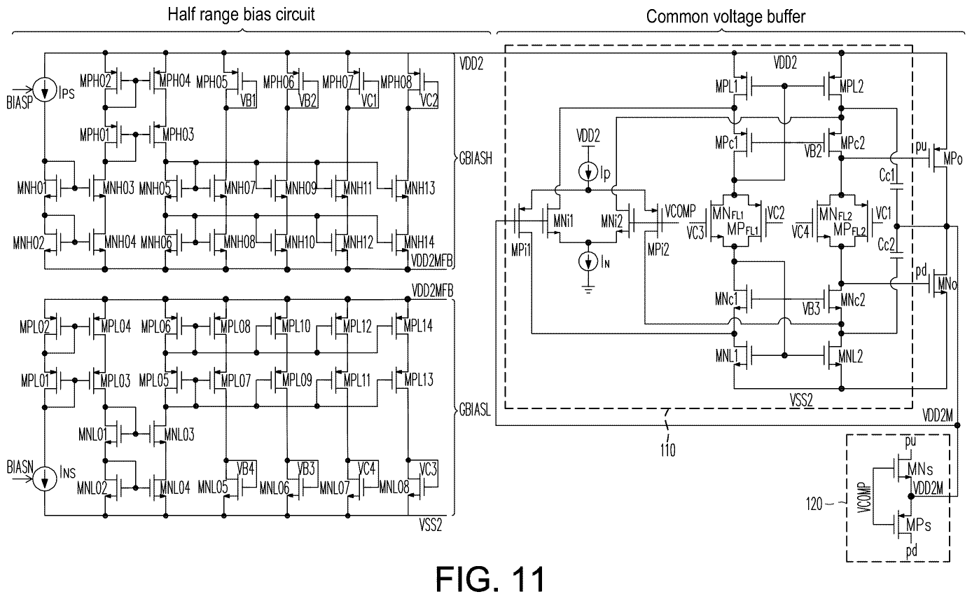

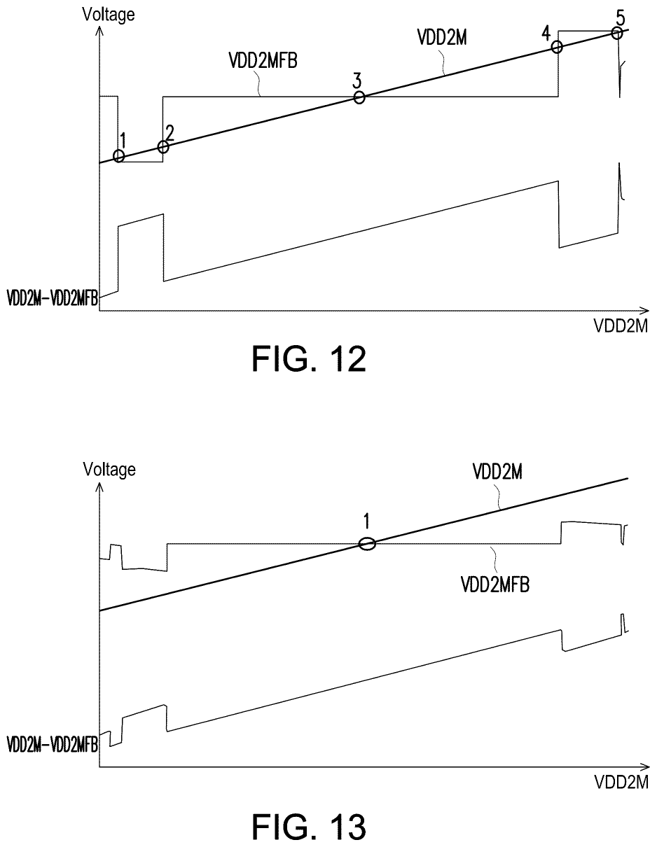

FIG. 11 illustrates a circuit diagram of a half range bias circuit for simulation environment settings to perform DC stable operating point check on a common voltage buffer. FIG. 12 illustrates a simulation waveform diagram of a common voltage buffer without a bouncing-controlled circuit performing DC stable operating point check. FIG. 13 illustrates a simulation waveform diagram of a common voltage buffer with a bouncing-controlled circuit performing DC stable operating point check. Referring to FIG. 1 to FIG. 3 along with FIG. 11 to FIG. 13, FIG. 11 shows the closed-loop common voltage buffer for DC stable operating point check environment settings for the half range bias circuit. Under the circumstances, the connection between the output of the common voltage buffer (such as 100, 101) and the half range bias circuit 12 is disconnected, and the system middle voltage VDD2M is replaced with an independent voltage VDD2MFB. By scanning the system middle voltage VDD2M and observing the voltage VDD2MFB, the working status of the common voltage buffer may be understood. When there is only one stable operating point, there will be only one system middle voltage VDD2M introduced, making the system middle voltage VDD2M-voltage VDD2MFB=0 (normal operation).

According to FIG. 12, the common voltage buffer without adopting the bouncing-controlled circuit 120 introduces five stable operating points (as shown by five intersection points “o”). When the system middle voltage VDD2M rises from the system low voltage VSS2, this phenomenon may make boot operations challenging, because the system middle voltage VDD2M stops at the second stable operating point. However, through using the common voltage buffer (such as 100, 101) with the bouncing-controlled circuit 120, the simulation results shown in FIG. 13 indicate only one stable operating point, allowing the common voltage buffer (such as 100, 101) to operate normally.

Applications may benefit from display systems with low DC/AC power consumption. Therefore, example embodiments provide a bouncing-controlled common voltage buffer and a source driver including the common voltage buffer of power-saving source driver and low power consumption display system, for performing boot operations. In addition, the method, according to example embodiments, may control the overshoot/undershoot of the output voltage of the common voltage buffer while maintaining occupied circuit area and maintaining existing DC power consumption. Due to the bouncing-control, AC power consumption is reduced, performance is improved, and image quality and production yield are maintained.

As described herein, any devices, systems, modules, portions, units, controllers, circuits, and/or portions thereof according to any of the example embodiments, and/or any portions thereof (including, without limitation, the full range bias circuit 11, the half range bias circuit 12, the level shifter 13, the digital-to-analog converter 14, the source amplifier 15, the power-down buffer 16, the multiple gamma amplifiers 17a to 17b, the repair amplifier 18, and the common voltage buffer 101, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A bouncing-controlled common voltage buffer, comprising:
a P-type output transistor having a first terminal configured to receive a system high voltage, a control terminal configured to receive a pull-up control signal, and a second terminal configured to output a system middle voltage;
an N-type output transistor having a first terminal coupled to the second terminal of the P-type output transistor, a control terminal configured to receive a pull-down control signal, and a second terminal configured to receive a system low voltage;
an output control circuit configured to receive a comparison voltage, the system middle voltage and a plurality of biases, and the output control circuit configured to provide the pull-up control signal and the pull-down control signal; and
a bouncing-controlled circuit configured to receive the comparison voltage and the system middle voltage, and being coupled to the pull-up control signal and the pull-down control signal, the bouncing-controlled circuit configured to compare the comparison voltage with the system middle voltage, and, in response to a voltage level of the system middle voltage exceeding a voltage range that is based on a voltage level of the comparison voltage, the bouncing-controlled circuit configured to turn on one of the P-type output transistor or the N-type output transistor through the pull-up control signal or the pull-down control signal.

2. The bouncing-controlled common voltage buffer according to claim 1, wherein the bouncing-controlled circuit comprises:
a first N-type transistor having a first terminal coupled to the pull-up control signal, a control terminal configured to receive the comparison voltage, and a second terminal configured to receive the system middle voltage; and
a first P-type transistor having a first terminal configured to receive the system middle voltage, a control terminal configured to receive the comparison voltage, and a second terminal coupled to the pull-down control signal.

3. The bouncing-controlled common voltage buffer according to claim 2, wherein the bouncing-controlled circuit is further configured to turn on one of the P-type output transistor or the N-type output transistor in response to the voltage level of the system middle voltage exceeding the voltage range that is further based on a first transistor threshold for turning on the first P-type transistor and a second transistor threshold for turning on the first N-type transistor.

4. The bouncing-controlled common voltage buffer according to claim 3, wherein a high voltage threshold of the voltage range is based on a sum of the comparison voltage and the first transistor threshold, and a low voltage threshold of the voltage range is based on a difference between the comparison voltage and the second transistor threshold.

5. The bouncing-controlled common voltage buffer according to claim 1, wherein the output control circuit comprises:
a first current source having a first terminal coupled to the system high voltage and a second terminal;
a second current source having a first terminal and a second terminal coupled to a ground voltage;
a second P-type transistor having a first terminal coupled to the second terminal of the first current source, a control terminal configured to receive the system middle voltage, and a second terminal;
a second N-type transistor having a first terminal, a control terminal configured to receive the system middle voltage, and a second terminal coupled to the first terminal of the second current source;
a third N-type transistor having a first terminal, a control terminal configured to receive the comparison voltage, and a second terminal coupled to the first terminal of the second current source;
a third P-type transistor having a first terminal coupled to the second terminal of the first current source, a control terminal configured to receive the comparison voltage, and a second terminal;
a fourth P-type transistor having a first terminal configured to receive the system high voltage, a control terminal, and a second terminal coupled to the first terminal of the second N-type transistor;
a fifth P-type transistor having a first terminal configured to receive the system high voltage, a control terminal coupled to the control terminal of the fourth P-type transistor, and a second terminal coupled to the first terminal of the third N-type transistor;
a sixth P-type transistor having a first terminal coupled to the second terminal of the fourth P-type transistor, a control terminal configured to receive a first bias of the plurality of biases, and a second terminal coupled to the control terminal of the fourth P-type transistor;
a seventh P-type transistor having a first terminal coupled to the second terminal of the fifth P-type transistor, a control terminal configured to receive the first bias, and a second terminal providing the pull-up control signal;
a fourth N-type transistor having a first terminal coupled to the second terminal of the sixth P-type transistor, a control terminal configured to receive a second bias of the plurality of biases, and a second terminal;
an eighth P-type transistor having a first terminal coupled to the second terminal of the sixth P-type transistor, a control terminal configured to receive a third bias of the plurality of biases, and a second terminal coupled to the second terminal of the fourth N-type transistor;
a fifth N-type transistor having a first terminal coupled to the second terminal of the seventh P-type transistor, a control terminal configured to receive a fourth bias of the plurality of biases, and a second terminal providing the pull-down control signal;
a ninth P-type transistor having a first terminal coupled to the second terminal of the seventh P-type transistor, a control terminal configured to receive a fifth bias of the plurality of biases, and a second terminal coupled to the second terminal of the fifth N-type transistor;
a sixth N-type transistor having a first terminal coupled to the second terminal of the fourth N-type transistor, a control terminal configured to receive a sixth bias of the plurality of biases, and a second terminal coupled to the second terminal of the second P-type transistor;
a seventh N-type transistor having a first terminal coupled to the second terminal of the fifth N-type transistor, a control terminal configured to receive the sixth bias, and a second terminal coupled to the second terminal of the third P-type transistor;
an eighth N-type transistor having a first terminal coupled to the second terminal of the sixth N-type transistor, a control terminal coupled to the second terminal of the fourth N-type transistor, and a second terminal configured to receive the system low voltage;
a ninth N-type transistor having a first terminal coupled to the second terminal of the seventh N-type transistor, a control terminal coupled to the control terminal of the eighth N-type transistor, and a second terminal configured to receive the system low voltage;
a first capacitor coupled between the second terminal of the fifth P-type transistor and the system middle voltage; and
a second capacitor coupled between the system middle voltage and the second terminal of the seventh N-type transistor.

6. A source driver, comprising:
a bouncing-controlled common voltage buffer, comprising,
a P-type output transistor, having a first terminal configured to receive a system high voltage, a control terminal configured to receive a pull-up control signal, and a second terminal configured to output a system middle voltage;
an N-type output transistor having a first terminal coupled to the second terminal of the P-type output transistor, a control terminal configured to receive a pull-down control signal, and a second terminal configured to receive a system low voltage;
an output control circuit, configured to receive a comparison voltage, the system middle voltage and a plurality of biases, and the output control circuit configured to provide the pull-up control signal and the pull-down control signal; and
a bouncing-controlled circuit configured to receive the comparison voltage and the system middle voltage, and being coupled to the pull-up control signal and the pull-down control signal, the bouncing-controlled circuit is configured to compare the comparison voltage with the system middle voltage, and, in response to a voltage level of the system middle voltage exceeding a voltage range that is based on a voltage level of the comparison voltage, the bouncing-controlled circuit configured to turn on one of the P-type output transistor or the N-type output transistor through the pull-up control signal or the pull-down control signal;
a full range bias circuit configured to provide a positive global bias and a negative global bias;
a half range bias circuit coupled to the full range bias circuit and the bouncing-controlled common voltage buffer, to provide the plurality of biases, a first operation bias and a second operation bias based on the positive global bias, the negative global bias and the system middle voltage;
a level shifter coupled to the half range bias circuit and the bouncing-controlled common voltage buffer, and configured to receive display data to perform operations based on the first operation bias, the second operation bias, and the system middle voltage, and configured to provide shift display data;
a plurality of gamma amplifiers coupled to the half range bias circuit and the bouncing-controlled common voltage buffer, and configured to receive a reference voltage separately, wherein the plurality of gamma amplifiers are configured to operate based on the first operation bias, the second operation bias and the system middle voltage, and are configured to individually provide a gamma voltage;
a digital-to-analog converter coupled to the level shifter and the plurality of gamma amplifiers and configured to output a gamma voltage based on the shift display data and gamma voltages provided by the plurality of gamma amplifiers; and
a source amplifier coupled to the digital-to-analog converter, the half range bias circuit and the bouncing-controlled common voltage buffer, configured to operate based on the first operation bias, the second operation bias and the system middle voltage, and configured to provide a source voltage based on the gamma voltage.

7. The source driver according to claim 6, wherein the bouncing-controlled circuit comprises:
a first N-type transistor having a first terminal coupled to the pull-up control signal, a control terminal configured to receive the comparison voltage, and a second terminal configured to receive the system middle voltage; and
a first P-type transistor having a first terminal configured to receive the system middle voltage, a control terminal configured to receive the comparison voltage, and a second terminal coupled to the pull-down control signal.

8. The source driver according to claim 7, wherein the bouncing-controlled circuit is further configured to turn on one of the P-type output transistor or the N-type output transistor in response to the voltage level of the system middle voltage exceeding the voltage range that is further based on a first transistor threshold for turning on the first P-type transistor and a second transistor threshold for turning on the first N-type transistor.

9. The source driver according to claim 8, wherein a high voltage threshold of the voltage range is based on a sum of the comparison voltage and the first transistor threshold, and a low voltage threshold of the voltage range is based on a difference between the comparison voltage and the second transistor threshold.

10. The source driver according to claim 6, wherein the output control circuit comprises:
a first current source having a first terminal coupled to the system high voltage and a second terminal;
a second current source having a first terminal and a second terminal coupled to a ground voltage;
a second P-type transistor having a first terminal coupled to the second terminal of the first current source, a control terminal configured to receive the system middle voltage, and a second terminal;
a second N-type transistor having a first terminal, a control terminal configured to receive the system middle voltage, and a second terminal coupled to the first terminal of the second current source;
a third N-type transistor having a first terminal, a control terminal configured to receive the comparison voltage, and a second terminal coupled to the first terminal of the second current source;
a third P-type transistor having a first terminal coupled to the second terminal of the first current source, a control terminal configured to receive the comparison voltage, and a second terminal;
a fourth P-type transistor having a first terminal configured to receive the system high voltage, a control terminal, and a second terminal coupled to the first terminal of the second N-type transistor;
a fifth P-type transistor having a first terminal configured to receive the system high voltage, a control terminal coupled to the control terminal of the fourth P-type transistor, and a second terminal coupled to the first terminal of the third N-type transistor;
a sixth P-type transistor having a first terminal coupled to the second terminal of the fourth P-type transistor, a control terminal configured to receive a first bias of the plurality of biases, and a second terminal coupled to the control terminal of the fourth P-type transistor;
a seventh P-type transistor having a first terminal coupled to the second terminal of the fifth P-type transistor, a control terminal configured to receive the first bias, and a second terminal providing the pull-up control signal;
a fourth N-type transistor having a first terminal coupled to the second terminal of the sixth P-type transistor, a control terminal configured to receive a second bias of the plurality of biases, and a second terminal;
an eighth P-type transistor having a first terminal coupled to the second terminal of the sixth P-type transistor, a control terminal configured to receive a third bias of the plurality of biases, and a second terminal coupled to the second terminal of the fourth N-type transistor;
a fifth N-type transistor having a first terminal coupled to the second terminal of the seventh P-type transistor, a control terminal configured to receive a fourth bias of the plurality of biases, and a second terminal providing the pull-down control signal;
a ninth P-type transistor having a first terminal coupled to the second terminal of the seventh P-type transistor, a control terminal configured to receive a fifth bias of the plurality of biases, and a second terminal coupled to the second terminal of the fifth N-type transistor;
a sixth N-type transistor having a first terminal coupled to the second terminal of the fourth N-type transistor, a control terminal configured to receive a sixth bias of the plurality of biases, and a second terminal coupled to the second terminal of the second P-type transistor;
a seventh N-type transistor having a first terminal coupled to the second terminal of the fifth N-type transistor, a control terminal configured to receive the sixth bias, and a second terminal coupled to the second terminal of the third P-type transistor;
an eighth N-type transistor having a first terminal coupled to the second terminal of the sixth N-type transistor, a control terminal coupled to the second terminal of the fourth N-type transistor, and a second terminal configured to receive the system low voltage;
a ninth N-type transistor having a first terminal coupled to the second terminal of the seventh N-type transistor, a control terminal coupled to the control terminal of the eighth N-type transistor, and a second terminal configured to receive the system low voltage;
a first capacitor coupled between the second terminal of the fifth P-type transistor and the system middle voltage; and
a second capacitor coupled between the system middle voltage and the second terminal of the seventh N-type transistor.

11. The source driver according to claim 10, wherein the half range bias circuit comprises:
a high voltage terminal bias circuit configured to receive the positive global bias to provide the first operation bias, the first bias, the third bias and the fifth bias; and
a low voltage terminal bias circuit configured to receive the negative global bias to provide the second operation bias, the second bias, the fourth bias and the sixth bias.

12. The source driver according to claim 11, wherein the high voltage terminal bias circuit comprises:
a third current source having a first terminal coupled to the system high voltage and a second terminal, and configured to receive the positive global bias;
a tenth N-type transistor having a first terminal coupled to the second terminal of the third current source, a control terminal coupled to the first terminal of the tenth N-type transistor, and a second terminal;
an eleventh N-type transistor having a first terminal, a control terminal coupled to the control terminal of the tenth N-type transistor, and a second terminal;
a twelfth N-type transistor having a first terminal coupled to the second terminal of the tenth N-type transistor, a control terminal coupled to the first terminal of the twelfth N-type transistor, and a second terminal configured to receive the system middle voltage;
a thirteenth N-type transistor having a first terminal coupled to the second terminal of the eleventh N-type transistor, a control terminal coupled to the control terminal of the twelfth N-type transistor, and a second terminal configured to receive the system middle voltage;
a tenth P-type transistor having a first terminal configured to receive the system high voltage, a control terminal, and a second terminal coupled to the control terminal of the tenth P-type transistor;
an eleventh P-type transistor having a first terminal configured to receive the system high voltage, a control terminal coupled to the control terminal of the tenth P-type transistor, and a second terminal;
a twelfth P-type transistor having a first terminal coupled to the second terminal of the tenth P-type transistor, a control terminal, and a second terminal coupled to the control terminal of the twelfth P-type transistor and coupled to the first terminal of the eleventh N-type transistor;
a thirteenth P-type transistor having a first terminal coupled to the second terminal of the eleventh P-type transistor, a control terminal coupled to the control terminal of the twelfth P-type transistor, and a second terminal;
a fourteenth N-type transistor having a first terminal coupled to the second terminal of the thirteenth P-type transistor, a control terminal coupled to the first terminal of the fourteenth N-type transistor, and a second terminal;
a fifteenth N-type transistor having a first terminal, a control terminal coupled to the control terminal of the fourteenth N-type transistor, and a second terminal;
a sixteenth N-type transistor having a first terminal coupled to the second terminal of the fourteenth N-type transistor, a control terminal coupled to the first terminal of the sixteenth N-type transistor, and a second terminal configured to receive the system middle voltage;
a seventeenth N-type transistor having a first terminal coupled to the second terminal of the fifteenth N-type transistor, a control terminal coupled to the control terminal of the sixteenth N-type transistor, and a second terminal configured to receive the system middle voltage;
a fourteenth P-type transistor having a first terminal configured to receive the system high voltage, a control terminal configured to provide the first operation bias, and a second terminal coupled to the control terminal of the fourteenth P-type transistor and the first terminal of the fifteenth N-type transistor;
an eighteenth N-type transistor having a first terminal, a control terminal coupled to the control terminal of the fourteenth N-type transistor, and a second terminal;
a nineteenth N-type transistor having a first terminal coupled to the second terminal of the eighteenth N-type transistor, a control terminal coupled to the control terminal of the sixteenth N-type transistor, and a second terminal configured to receive the system middle voltage;
a fifteenth P-type transistor having a first terminal configured to receive the system high voltage, a control terminal configured to provide the first bias, and a second terminal coupled to the control terminal of the fifteenth P-type transistor and the first terminal of the eighteenth N-type transistor;
a twentieth N-type transistor having a first terminal, a control terminal coupled to the control terminal of the fourteenth N-type transistor, and a second terminal;
a twenty-first N-type transistor having a first terminal coupled to the second terminal of the twentieth N-type transistor, a control terminal coupled to the control terminal of the sixteenth N-type transistor, and a second terminal configured to receive the system middle voltage;
a sixteenth P-type transistor having a first terminal configured to receive the system high voltage, a control terminal configured to provide the fifth bias, and a second terminal coupled to the control terminal of the sixteenth P-type transistor and the first terminal of the twentieth N-type transistor;
a twenty-second N-type transistor having a first terminal, a control terminal coupled to the control terminal of the fourteenth N-type transistor, and a second terminal;
a twenty-third N-type transistor having a first terminal coupled to the second terminal of the twenty-second N-type transistor, a control terminal coupled to the control terminal of the sixteenth N-type transistor, and a second terminal configured to receive the system middle voltage; and
a seventeenth P-type transistor having a first terminal configured to receive the system high voltage, a control terminal configured to provide the third bias, and a second terminal coupled to the control terminal of the seventeenth P-type transistor and the first terminal of the twenty-second N-type transistor.

13. The source driver according to claim 11, wherein the low voltage terminal bias circuit comprises:
a fourth current source having a first terminal and a second terminal coupled to the system low voltage, and configured to receive the negative global bias;
an eighteenth P-type transistor having a first terminal configured to receive the system middle voltage, a control terminal, and a second terminal coupled to the control terminal of the eighteenth P-type transistor;
a nineteenth P-type transistor having a first terminal configured to receive the system middle voltage, a control terminal coupled to the control terminal of the eighteenth P-type transistor, and a second terminal;
a twentieth P-type transistor having a first terminal coupled to the second terminal of the eighteenth P-type transistor, a control terminal, and a second terminal coupled to the control terminal of the twentieth P-type transistor and coupled to the first terminal of the fourth current source;
a twenty-first P-type transistor having a first terminal coupled to the second terminal of the nineteenth P-type transistor, a control terminal coupled to the control terminal of the twentieth P-type transistor, and a second terminal;
a twenty-fourth N-type transistor having a first terminal coupled to the second terminal of the twenty-first P-type transistor, a control terminal coupled to the first terminal of the twenty-fourth N-type transistor, and a second terminal;
a twenty-fifth N-type transistor having a first terminal, a control terminal coupled to the control terminal of the twenty-fourth N-type transistor, and a second terminal;
a twenty-sixth N-type transistor having a first terminal coupled to the second terminal of the twenty-fourth N-type transistor, a control terminal coupled to the first terminal of the twenty-sixth N-type transistor, and a second terminal configured to receive the system low voltage;
a twenty-seventh N-type transistor having a first terminal coupled to the second terminal of the twenty-fifth N-type transistor, a control terminal coupled to the control terminal of the twenty-sixth N-type transistor, and a second terminal configured to receive the system low voltage;
a twenty-second P-type transistor having a first terminal configured to receive the system middle voltage, a control terminal, and a second terminal coupled to the control terminal of the twenty-second P-type transistor;
a twenty-third P-type transistor having a first terminal configured to receive the system middle voltage, a control terminal coupled to the control terminal of the twenty-second P-type transistor, and a second terminal;
a twenty-fourth P-type transistor having a first terminal coupled to the second terminal of the twenty-second P-type transistor, a control terminal, and a second terminal coupled to the control terminal of the twenty-fourth P-type transistor and coupled to the first terminal of the twenty-fifth N-type transistor;
a twenty-fifth P-type transistor having a first terminal coupled to the second terminal of the twenty-third P-type transistor, a control terminal coupled to the control terminal of the twenty-fourth P-type transistor, and a second terminal;
a twenty-eighth N-type transistor having a first terminal coupled to the second terminal of the twenty-fifth P-type transistor, a control terminal coupled to the first terminal of the twenty-eighth N-type transistor and providing the second operation bias, and a second terminal configured to receive the system low voltage;
a twenty-sixth P-type transistor having a first terminal configured to receive the system middle voltage, a control terminal coupled to the control terminal of the twenty-second P-type transistor, and a second terminal;
a twenty-seventh P-type transistor having a first terminal coupled to the second terminal of the twenty-sixth P-type transistor, a control terminal coupled to the control terminal of the twenty-fourth P-type transistor, and a second terminal;
a twenty-ninth N-type transistor having a first terminal coupled to the second terminal of the twenty-seventh P-type transistor, a control terminal coupled to the first terminal of the twenty-ninth N-type transistor and configured to provide the sixth bias, and a second terminal configured to receive the system low voltage;
a twenty-eighth P-type transistor having a first terminal configured to receive the system middle voltage, a control terminal coupled to the control terminal of the twenty-second P-type transistor, and a second terminal;
a twenty-ninth P-type transistor having a first terminal coupled to the second terminal of the twenty-eighth P-type transistor, a control terminal coupled to the control terminal of the twenty-fourth P-type transistor, and a second terminal;
a thirtieth N-type transistor having a first terminal coupled to the second terminal of the twenty-ninth P-type transistor, a control terminal coupled to the first terminal of the thirtieth N-type transistor and configured to provide the fourth bias, and a second terminal configured to receive the system low voltage;
a thirtieth P-type transistor having a first terminal configured to receive the system middle voltage, a control terminal coupled to the control terminal of the twenty-second P-type transistor, and a second terminal;
a thirty-first P-type transistor having a first terminal coupled to the second terminal of the thirtieth P-type transistor, a control terminal coupled to the control terminal of the twenty-fourth P-type transistor, and a second terminal; and
a thirty-first N-type transistor having a first terminal coupled to the second terminal of the thirty-first P-type transistor, a control terminal coupled to the first terminal of the thirty-first N-type transistor and configured to provide the second bias, and a second terminal configured to receive the system low voltage.

14. The source driver according to claim 6, further comprising:
a power-down buffer coupled to the source amplifier, the half range bias circuit and the bouncing-controlled common voltage buffer, configured to perform the operations based on the first operation bias, the second operation bias and the system middle voltage, and configured to determine whether to output the source voltage based on a system power supply status.

15. The source driver according to claim 6, further comprising:
a repair amplifier coupled to the source amplifier, the half range bias circuit and the bouncing-controlled common voltage buffer, configured to perform the operations based on the first operation bias, the second operation bias and the system middle voltage, and configured to determine whether to provide a compensation voltage corresponding to the source voltage based on a repair signal.
